(19) United States
(12) Patent Application Publication
(10) Pub. No.: US 2018/0077861 A1
(43) Pub. Date: Mar. 22, 2018

(54) Lawn Trimmer Assembly

(71) Applicant: Jerry Lego, Shawboro, NC (US)

(72) Inventor: Jerry Lego, Shawboro, NC (US)

(21) Appl. No.: 15/710,932

(22) Filed: Sep. 21, 2017

Related U.S. Application Data
(60) Provisional application No. 62/397,391, filed on Sep. 21, 2016.

(51) Int. Cl. A01D 34/416; A01D 34/84

(52) U.S. Cl. CPC A01D 34/4165; A01D 2101/00; A01D 34/84

(57) ABSTRACT

A weed trimmer attached to a lawn mower for trimming along the edges of a lawn. A trimmer shaft extends downward from a motor. A trimmer line extends outward at the bottom of the trimmer shaft perpendicular to a lawn surface. An arm member connects the motor to a bracket secured to a lawn mower. The connections between the arm member and the motor and the arm member and the bracket can be pivotal, allowing the height of the trimmer line relative to the lawn surface to be adjusted.

### CROSS REFERENCE TO RELATED APPLICATIONS

This application claims the benefit of U.S. Provisional Application No. 62/397,391 filed on Sep. 21, 2016. The above identified patent application is herein incorporated by reference in its entirety to provide continuity of disclosure.

### BACKGROUND OF THE INVENTION

The present invention relates to weed trimmers mountable to the deck of a riding or traditional push mower. More specifically, the present invention provides a weed trimmer mountable to the deck of a lawn mower adapted to have an adjustable height relative to a lawn surface.

Proper landscaping often requires a homeowner or landscaper to revisit areas of a lawn after mowing with a weed trimmer to cut certain areas that cannot be safely reached or accurately cut with a lawn mower, e.g. edges of a lawn around a fence. Additionally, this process necessitates using two separate pieces of equipment, a lawn mower and weed trimmer, both with their own fuel source and labor consumption.

Several devices have been proposed to expedite the process of mowing and trimming the edges of a lawn. One such device provides a lawn mower deck with an attached weed trimmer. The weed trimmer of this device linked to an arm member that enables the weed trimmer to pivot between a horizontal plane and vertical plane. The weed trimmer of this device can also fold into a retracted position when not in use. Having a trimmer line with adjustable height relative to a lawn surface

However, the known devices do not provide a weed trimmer mounted to the deck of a lawn mower that enables a user to adjust the height of the weed trimmer while maintaining the weed trimmer's horizontal plane relative to a lawn surface. In light of the devices disclosed in the known art, it is submitted that the present invention substantially diverges in design elements from the known art and consequently it is clear that there is a need in the art for an improvement to existing weed trimmers mounted to a lawn mower. In this regard, the instant invention substantially fulfills these needs.

### SUMMARY OF THE INVENTION

In view of the foregoing disadvantages inherent in the known types of lawn mower deck mounted weed trimmers now present in the prior art, the present invention provides a lawn mower deck mounted weed trimmer wherein the same can be utilized for providing convenience for the user when landscaping a diverse lawn.

The present assembly comprises a trimmer shaft extends downward from a motor. The motor is configured to rotate the trimmer shaft about a longitudinal axis. A trimmer line extends horizontally outward from the bottom end of the trimmer shaft. An arm member connects the motor to a lawn mower deck. The connections between the arm member and the motor and the arm member and the lawn mower deck are configured to selectively transition the motor between a raised position and a lowered position. The trimmer line remains parallel to the lawn surface in both positions. The arm member is secured to the lawn mower deck with a bracket.

One object of the present invention is to provide a lawn trimmer assembly wherein a rotating trimmer line is mounted to a lawn mower deck to allow a user to landscape with a single device.

Another object of the present invention is to provide a lawn trimmer assembly wherein a rotating trimmer line mounted to a lawn mower deck has an adjustable height.

Yet another object of the present invention is to provide a lawn trimmer assembly wherein a rotating trimmer line is mounted to a lawn mower deck by an arm member, extending the reach of the rotating trimmer beyond the edge of a lawn mower deck.

A further object of the present invention is to provide a lawn trimmer assembly wherein a rotating trimmer line mounted to a lawn mower deck has a retracted position and a deployed position.

An additional object of the present invention is to provide a lawn trimmer assembly wherein the height and horizontal position of a rotating trimmer line mounted to a lawn mower deck is controlled by the operator of the lawn mower via a control switch.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front perspective view of an embodiment of the lawn trimmer assembly.

FIG. 1B shows a front perspective view of an embodiment of the lawn trimmer assembly in an alternative position.

FIG. 2 shows a front elevation view of an embodiment of the lawn trimmer assembly.

FIG. 3 shows a front elevation view of a second embodiment of the lawn trimmer assembly.

FIG. 4 shows a perspective view of an alternative arrangement of an embodiment of the lawn trimmer assembly attached to a ride-on mower.

FIG. 5 shows a perspective view of an embodiment of the lawn trimmer assembly in use.

### DETAILED DESCRIPTION OF THE INVENTION

Reference is made herein to the attached drawings. Like reference numerals are used throughout the drawings to depict like or similar elements of the lawn trimmer assembly. The figures are intended for representative purposes only and should not be considered to be limiting in any respect.

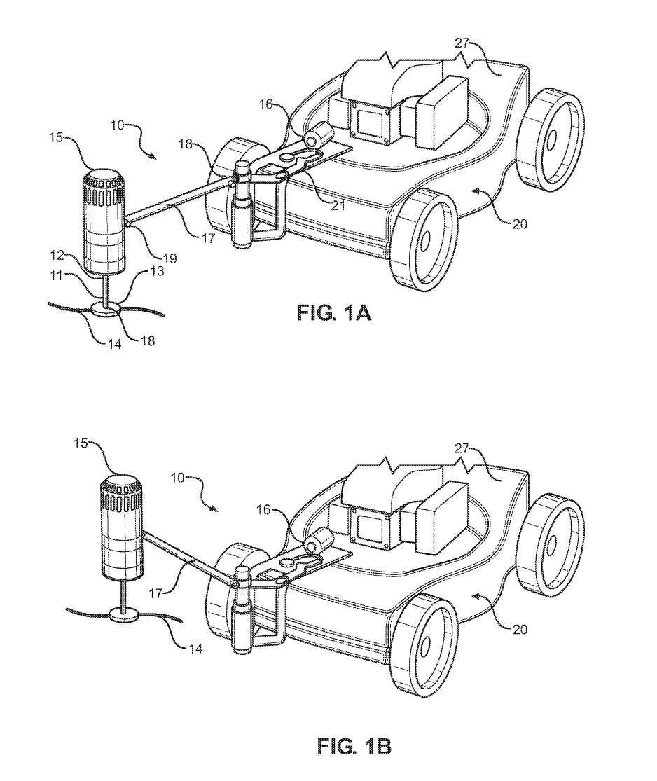

Referring now to FIGS. 1A and 1B, there are shown a perspective views of an embodiment of the lawn trimmer assembly. The lawn trimmer assembly 10 comprises a trimmer shaft 11 rotatably affixed to a motor 15 at a proximal end 12 of the trimmer shaft 11. The motor 15 is operably connected to a power source 16. The power source 16 in one embodiment is the battery of a ride-on mower 25, as shown in FIG. 4. In other embodiments, the power source 16 is a battery independent of the engine of a lawn mower, e.g. a lithium battery placed on an embodiment of the lawn trimmer assembly attached to a push mower deck. The motor 15 is configured to rotate the trimmer shaft 11 about a central longitudinal axis 18. In the shown embodiment, the motor 15 rotates the trimmer shaft 11 at 8000 revolutions per minute (RPM), but, in other embodiments, the motor 15 can rotate the trimmer shaft 11 at a range of revolutions per minute.

At the distal end 13 of the trimmer shaft 11 is a trimmer line 14 that extends radially outward relative to a longitudinal axis 18 of the trimmer shaft 11. In the present embodiment, the trimmer line 14 extends horizontally outward from the trimmer shaft 11 in opposing directions. Further, in the embodiment shown, the distal end 13 of the trimmer shaft 11 is a trimmer line head that contains a central spool, around which extra trimmer line is wrapped. In some embodiments, the spool is separated into two sections by a divider, each section having a trimmer line wrapped around it, wherein an end portion of the trimmer line protrudes through an aperture on the trimmer line head to extend horizontally outwards from the trimmer shaft in opposing directions. The trimmer line head may be a bump feed trimmer line head.

An arm member 17 connects the motor 15 to a lawn mower deck 20. A first end 18 of the arm member 17 is fastened to the lawn mower deck 20 and a second end 19 of the arm member 17 is fastened to the motor 15. The arm member 17 is configured to selectively move the motor 15, and thus the trimming line 14, between a lowered position, depicted in FIG. 1A, and a raised position, depicted in FIG. 1B. In the lowered position, the arm member 17 is substantially parallel to a plane extending from the top surface 27 of the lawn mower deck 20. However, in some other embodiments, the range of motion is greater and the second end 19 of the arm member 17 can be positioned below the deck plane. In the raised position, the arm member 17 is approximately angled 45-degrees upward from the plane extending from the top surface 27 of the lawn mower deck 20. However, in other embodiments, the incident angle between the arm member 17 and the plane of the lawn mower deck 20 when the arm is in a raised position is some angle between 45-degrees and 90-degrees. The arm member 17 is configured to maintain a selected position between the raised position and lowered position. This selectivity may be accomplished by a spring bias mechanism or a pneumatic mechanism.

In the embodiment shown in the figures, the first end 18 of the arm member 17 is secured to the lawn mower deck 20 by a mounting bracket 21. Additionally, the first end 18 and second end 19 of the arm member 17 are pivotally fastened to the motor 15 and mounting bracket 21, respectively. These fastenings are configured to allow the motor 15 to selectively move between the lowered and raised positions, while concurrently maintaining the trimming line's 14 orientation substantially parallel to a lawn surface, see FIG. 1B. In one embodiment, the pivotal fastenings are t-hinges.

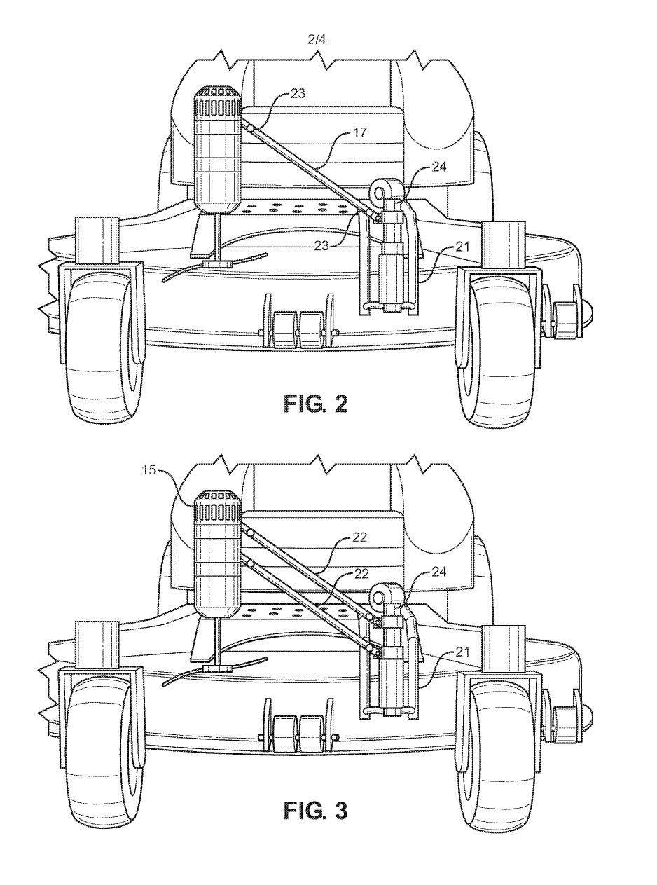

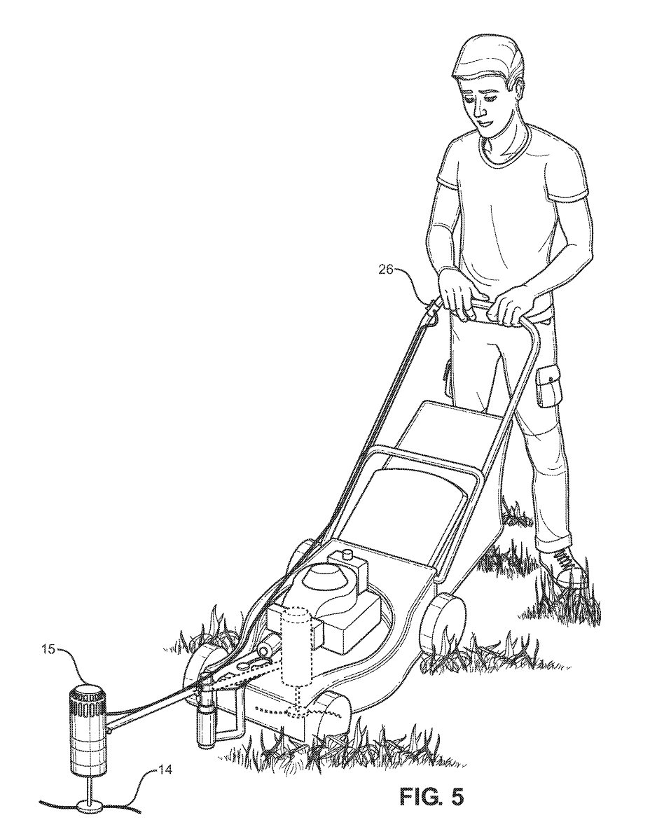

Referring now to FIG. 2, there is shown a front elevation view of an embodiment of the lawn trimmer assembly. Here, the first end of the arm member 17 is connected to a swivel rod 24 configured to selectively pivot the arm member 17 between a deployed position and a retracted position, see FIG. 5. The swivel rod 24 is pivotally fastened to the lawn mower deck 20. In the illustrated embodiment, the swivel rod 24 is pivotally fastened to the lawn mower deck 20 through the mounting bracket 21. In this arrangement, the swivel rod 24 resembles a hinge pin, enabling the arm member 17 to swing laterally relative to the mower deck 20. In the deployed position, the arm member 17 extends perpendicularly from an edge of the lawn mower deck 20. In the retracted position, the arm member 17 is oriented 90-degrees left or right of the deployed position. In combination with the vertical movement of the motor 15 enabled by the connections between the motor 15, arm member 17 and swivel rod 24, the connection of the arm member 17 to the swivel rod 24 enables the motor 15 to be moved horizontally as well as vertically.

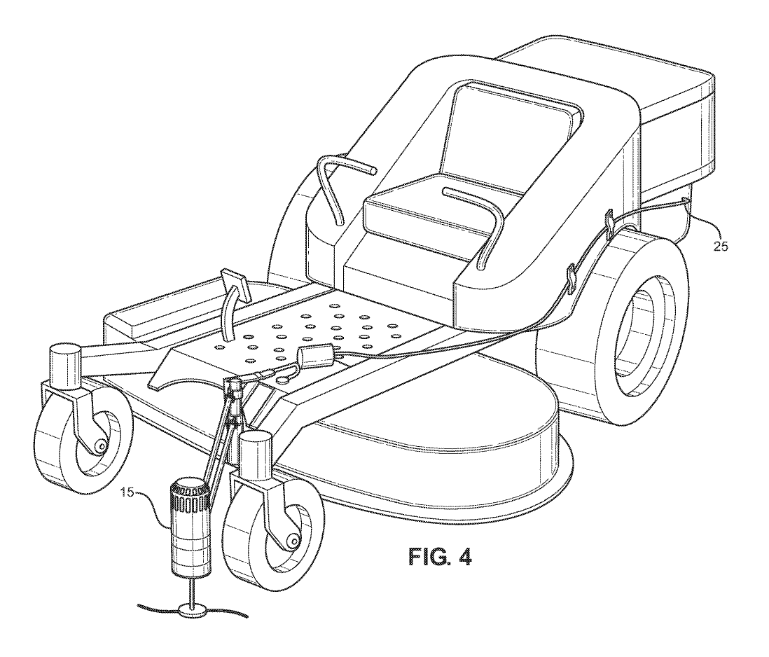

Referring now to FIG. 3, in the embodiment shown, a pair of arm members 22 connects the motor 15 to the lawn mower deck 20. Just as with a single arm member, the pair of arm members 22 can also be coupled to a mounting bracket 21 or swivel rod 24 to create a nexus between the pair of arm members 22 and the lawn mower deck 20. A pair of arm members 22 adds strength and stability to the lawn trimmer assembly.

To actuate the motor 15 on the lawn trimmer assembly a switch 26 is provided. As shown in FIG. 5, the switch 26 is conveniently located for manual operation by a user of the lawn mower. On a push mower, the switch 26 can be located on the handle bar. On a ride-on mower the switch 26 can be located on a panel adjacent to the seat. The switch 26 is configured to start and stop the motor when actuated to a first and second position, respectively. In the embodiment shown in the figures, the switch 26 is operably connected to the arm member 17 and swivel rod 24 and is configured to control the vertical and horizontal positions of the motor 15. In some embodiments, the switch may have a user interface with four directional arrows: left, right, up and down, wherein actuation of the left arrow rotates the swivel rod to the left, actuation of the right arrow rotates the swivel rod to the right, actuation of the up arrow raises the motor 15 and actuation of the down arrow lowers the motor 15. This motor control may be accomplished by operably connecting the arm member 17 and swivel rod 24 to an electrically driven gear box. In these embodiment, the switch 26 and the gear box are electrically connected to a microcontroller, wherein the microcontroller is configured to interpret a direction pressed on a switch and output an electrical signal to the gear box to move the arm member 17 or swivel rod 24 in the corresponding direction.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A lawn trimmer assembly comprising:
a trimmer shaft affixed to a motor, the motor operably connected to a power source, wherein the trimmer shaft is configured to rotate about a longitudinal axis;
a trimming line affixed to the trimmer shaft, wherein a wire extends radially outward from the trimmer shaft;
an arm member having a first end and a second end, wherein the first end is fastened to a lawn mower deck and the second end is fastened to the motor, wherein each connection between the first end and the mounting bracket and the second end and the motor are configured to selectively move the motor between a raised position and a lowered position, wherein the trimming line remains parallel to a lawn surface in both the raised position and lowered position.

2) The lawn trimmer assembly of claim 1, wherein the arm member is pivotally fastened to a mounting bracket at the first end of the arm member and pivotally fastened to the motor at the second end of the arm member, wherein the mounting bracket is mounted to the lawn mower deck.

3) The lawn trimmer assembly of claim 2, wherein the arm member is pivotally fastened to the mounting bracket at the first end of the arm member by a t-hinge joint and pivotally fastened to the motor at the second end of the arm member by a t-hinge joint.

4) The lawn trimmer assembly of claim 1, wherein arm member comprises a pair of arm members, wherein each of the pair of arms are secured to the lawn mower deck at a first end of each arm of the pair of arms and to the motor at a second end of each arm of the pair of arms.

5) The lawn trimmer assembly of claim 4, wherein the pair of arm members is pivotally secured to a mounting bracket at the first end of each arm of the pair of arms and to the motor at the second end of each arm of the pair of arms, wherein the mounting bracket is mounted to the lawn mower deck.

6) The lawn trimmer assembly of claim 1, wherein the first end of the arm member is connected to a swivel rod, the swivel rod being pivotally fastened to the mounting bracket, wherein the swivel rod is configured to selectively pivot the arm member between a deployed position and a retracted position, wherein the arm member in the deployed position extends perpendicularly from a side the lawn mower deck and the arm member in the retracted position is parallel to the side of the lawn mower deck.

7) The lawn trimmer assembly of claim 6, wherein the first end of the arm member is pivotally fastened to the swivel rod.

8) The lawn trimmer assembly of claim 6, wherein the arm member comprises a pair of arm members, wherein each arm member of the pair of arm members is connected to a swivel rod at the first end of each arm member of the pair of arm members.

9) The lawn trimmer assembly of claim 8, wherein the pair of arm members is pivotally fastened to the swivel rod at the first end of each arm member of the pair of arm members and pivotally fastened to the motor at the second end of each arm member of the pair of arm members.

10) The lawn trimmer assembly of claim 1, wherein the power source is a battery disposed within a ride-on lawn mower engine assembly.

11) The lawn trimmer assembly of claim 1, wherein the power source is actuated by a switch disposed on a handle of a lawn mower.

12) The lawn trimmer assembly of claim 1, further comprising an arm member switch configured to raise and lower the second end of the arm member, the arm member switch disposed on a lawn mower.

13) The lawn trimmer assembly of claim 6, further comprising an arm member switch configured to move the second end of the arm member between the deployed and retracted positions is disposed on a lawn mower.

14) A lawn trimmer assembly, comprising:
a mounting bracket configured to removably affix to a lawn mower deck, the mounting bracket pivotally connected to a swivel rod;
a first end of an arm member pivotally affixed to swivel rod;
a second end of the arm member pivotally affixed to a motor;
the motor operably connected to a trimmer shaft, the trimmer shaft configured to rotate a trimmer line and cause the rotating trimmer line to cut engaged grass;
wherein rotation of the swivel rod is along a first plane of rotation and rotation of the first end of the arm member is along a second plane of rotation, wherein the first plane of rotation and the second plane of rotation intersect;
wherein rotation of the swivel rod causes the motor, the trimmer shaft, and the trimmer line to swing between a deployed position and a retracted position;
the deployed position comprises the arm member disposed perpendicularly from a side the lawn mower deck;
the retracted position comprises the arm member disposed parallel to the side of the lawn mower deck;
wherein rotation of the first end of the arm member causes the motor, the trimmer shaft, and the trimmer line to rotate between a raised position and a lowered position, the raised position comprising the arm member forming an angle between a plane extending from the lawn mower deck, the lowered position comprising the arm member being parallel the lawn mower deck;
wherein selective rotation of the second end of the arm member is configured to disposed the trimmer line parallel the lawn mower deck.
